(19) United States
(12) Patent Application Publication
(10) Pub. No.: US 2007/0124065 A1
(43) Pub. Date: May 31, 2007

(54) MAP TRANSMISSION SYSTEM AND METHOD THEREOF

(75) Inventors: David Ho, Taipei (TW); Wei LIANG, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INVENTEC APPLIANCES CORP., Taipei (TW)

(21) Appl. No.: 11/535,496

(22) Filed: Sep. 27, 2006

(30) Foreign Application Priority Data
Nov. 25, 2005 (TW) 94141571

(51) Int. Cl. G01C 21/32

(52) U.S. Cl. 701/208; 340/995.12

(57) ABSTRACT

A map transmission system and a method thereof are disclosed. The system includes a database, a sender, and a receiver. The database stores at least one map data. The sender generates a map frame data based on the map to be transmitted and converts the map frame data into a vector map data through the database, and then the sender transmits the vector map data to a remote site via a network. The receiver receives the vector map data and displays the vector map data by using a map engine application program.

### CROSS-REFERENCE TO RELATED APPLICATION

This application claims the priority benefit of Taiwan application serial no. 94141571, filed on Nov. 25, 2005. All disclosure of the Taiwan application is incorporated herein by reference.

### BACKGROUND OF THE INVENTION

1. Field of the Invention

The present invention relates to a map transmission system and a method thereof. More particularly, the present invention relates to a map transmission system which converts a map into a vector map data to be transmitted and a method thereof.

2. Description of Related Art

Along with the rapid development of telecommunication technology, electronic apparatus with global positioning system (GPS), such as mobile phone, personal digital assistant (PDA), or navigation device, has become an indispensable consumer product in our daily life because of its real-time navigation function.

Presently, an electronic apparatus with GPS usually has screenshot function for capturing part of the map, and then the electronic apparatus transmits the part of the map to another electronic apparatus via the Internet, so as to exchange the map information. In conventional technique, the captured map is mapped to a corresponding space in a virtual raster image, and each raster is filled up with color pixels so as to form the entire image, and the captured map is transmitted in an image file format such as graphics interchange format (GIF), joint photographic experts group (JPEG), or windows bit map (BMP). The received map cannot be zoomed randomly if the image quality is not good enough. By enlarging the map, the size of each pixel raster is increased accordingly, thus the definition of the image is reduced. Moreover, when a map is transmitted, a lot of information is contained in a compressed map to enable it decompressing to the original image file, thus, the quantity of data to be transmitted is very large, and which increases the transmission time.

Accordingly, a map transmission system and a method thereof are provided in the present invention for resolving the problems described above.

### SUMMARY OF THE INVENTION

Accordingly, the present invention is directed to provide a map transmission system and a method thereof, wherein a map to be transmitted is converted into a vector map data so that the quantity of data to be transmitted is reduced and accordingly the map can be transmitted quickly.

To achieve the aforementioned objective, the map transmission system in the present invention includes a database, a sender, and a receiver. Wherein, the database stores at least one map data. The sender generates a map frame data based on the map to be transmitted and converts the map frame data into a vector map data through the database, and then the sender transmits the vector map data to a remote site via a network. The receiver receives the vector map data and displays the vector map data by using a map engine application program.

As described above, the map transmission method in the present invention includes the following steps. First, a database is set to store at least one map data. Then, a sender is provided to generate a map frame data based on the map to be transmitted and to convert the map frame data into a vector map data through the database, and then the sender is directed to transmit the vector map data to a remote site via a network. Finally, a receiver is provided to receive the vector map data and to display the vector map data by using a map engine application program. Accordingly, the purpose of reducing the time of transmitting the map is accomplished.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a map transmission system in the present invention.

FIG. 2 is a diagram of an electronic apparatus in the present invention.

FIG. 3 is a flowchart illustrating the map transmission method of the sender according to an embodiment of the present invention.

FIG. 4 is a flowchart illustrating the map transmission method of the receiver according to an embodiment of the present invention.

FIG. 5 is a diagram illustrating the format of the vector map data according to an embodiment of the present invention.

FIG. 6 is a diagram illustrating the format of the layer content data according to an embodiment of the present invention.

FIG. 7 is a diagram illustrating the format of the layer code content data according to an embodiment of the present invention.

### DESCRIPTION OF EMBODIMENTS

A map transmission system and a method thereof according to exemplary embodiments of the present invention will be described in detail with reference to the accompanying drawings, wherein like reference numerals refer to the like elements throughout.

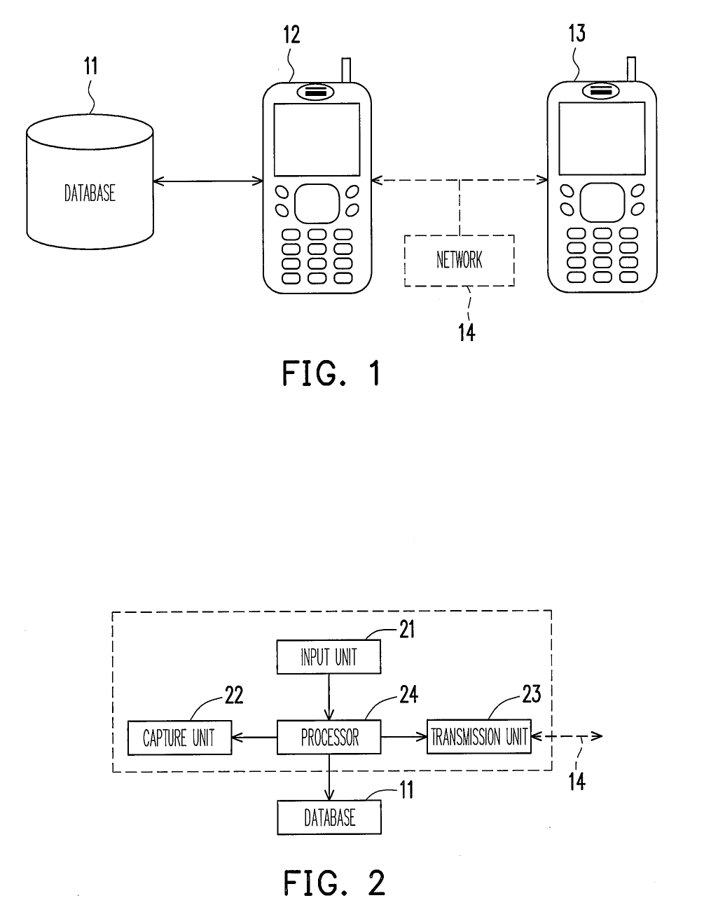

FIG. 1 is a diagram of a map transmission system in the present invention. Referring to FIG. 1, the system includes a database 11, a sender 12, a receiver 13, and a network 14. The database 11 stores at least one map data. The sender 12 is set on an electronic device, such as a personal digital assistant (PDA), a navigation device, or a mobile phone with global positioning system (GPS). The sender 12 generates a map frame data based on the map to be transmitted and converts the map frame data into a vector map data through the database 11, and then the sender 12 transmits the vector map data to the receiver 13 via the network 14. The receiver 13 is set on another electronic device, such as a personal digital assistant (PDA), a navigation device, or a mobile phone with global positioning system (GPS). The receiver 13. receives the vector map data and displays the vector map data by using a map engine application program. Accordingly, the quantity of data to be transmitted can be reduced and the purpose of reducing the time of transmitting the map can be accomplished.

FIG. 2 is a diagram of an electronic apparatus applicable to the map transmission system in the present invention. Referring to FIG. 2, the electronic apparatus includes an input unit 21, a capture unit 22, a transmission unit 23, and a processor 24. The input unit 21 is used for inputting a map to be transmitted. The capture unit 22 generates a map frame data based on the map. The transmission unit 23 is connected to the network 14 wirelessly to transmit/receive a vector map data to/from a remote site. The processor 24 converts a map frame data into the vector map data through the database 11 or displays the received vector map data by using a map engine application program. Besides, the electronic apparatus of the sender or the receiver may be a personal digital assistant (PDA), a navigation device, or a mobile phone. The map frame data contains, for example, the coordinates of the top left corner and the bottom right corner of the map. The vector map data is transmitted in a packet and complies with hypertext transmission protocol (HTTP) or simple mail transfer protocol (SMTP). Moreover, with the format of the vector map data, the received map can be resized randomly without losing the definition of the map.

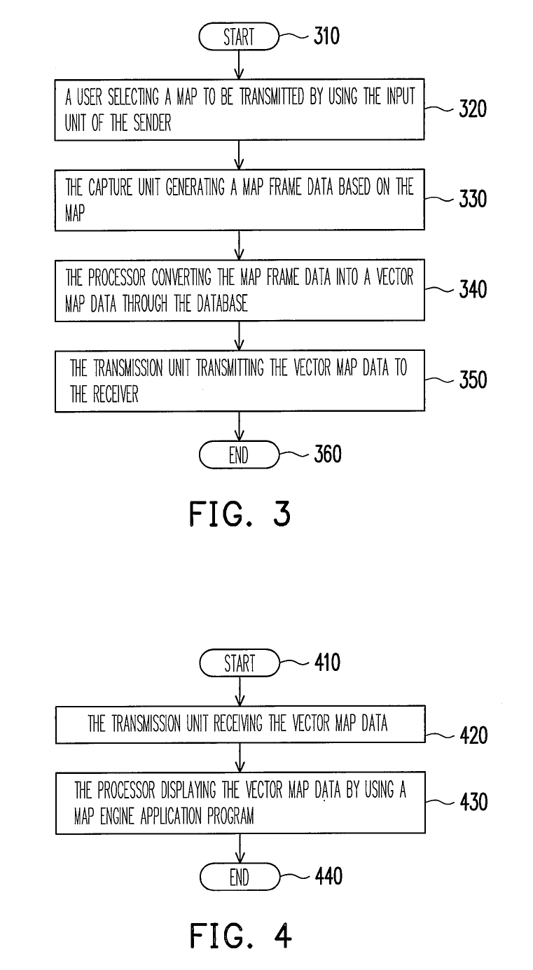

FIG. 3 is a flowchart illustrating the map transmission method of the sender according to an embodiment of the present invention. Referring to FIG. 3, the method includes the following steps:
step S310: start;
step S320: a user selecting the map to be transmitted by using the input unit of the sender;
step S330: the capture unit generating a map frame data based on the map;
step S340: the processor converting the map frame data into a vector map data through the database;
step S350: the transmission unit transmitting the vector map data to the receiver via a network; and
step S360: end.

FIG. 4 is a flowchart illustrating the map transmission method of the receiver according to the present invention. Referring to FIG. 4, the method includes the following steps:

step S410: start;

step S420: the transmission unit receiving the vector map data;

step S430: the processor displaying the vector map data by using a map engine application program; step S440: end.

In addition, the map transmission system divides the map into a plurality of equal layers according to x-axis and y-axis to reduce the data quantity thereof. The vector map data contains data of these layers.

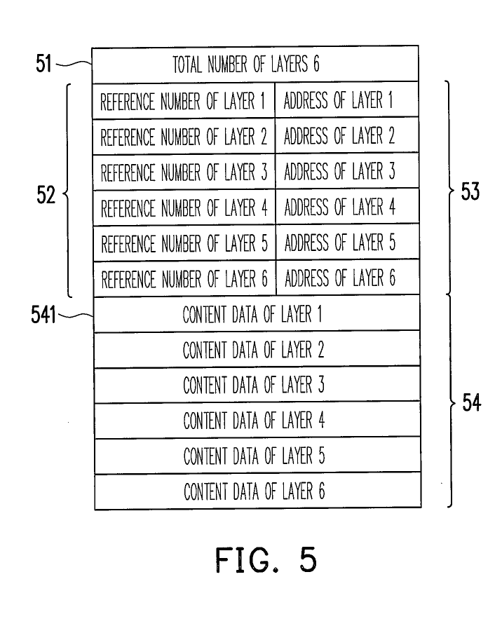

FIG. 5 is a diagram illustrating the format of a vector map data according to an embodiment of the present invention, wherein the map is divided into 6 layers. Referring to FIG. 5, the vector map data format contains a total layer number 51, layer reference numbers 52, layer addresses 53, and layer content data 54.

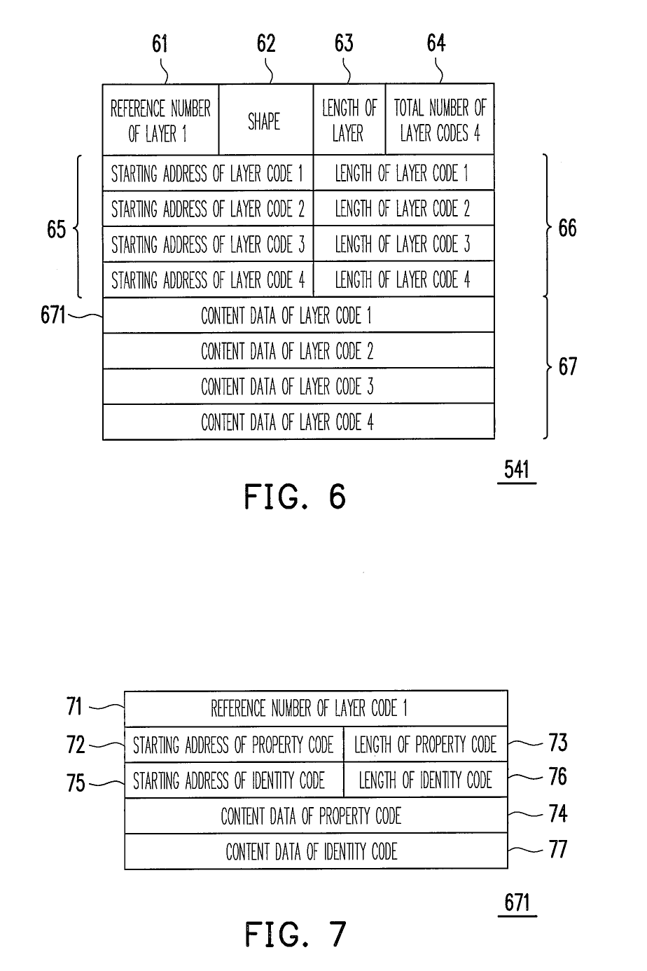

FIG. 6 is a diagram illustrating another format of a layer content data according to an embodiment of the present invention. With the content data 541 of layer 1 as an example, the layer content data contains a layer reference number 61, a shape 62, a layer length 63, and a total number 64, starting addresses 65, lengths 66, and content data 67 of layer codes. Besides, the content data of the other layers, such as layer 2, all have the same format.

FIG. 7 is a diagram illustrating another format of a layer code content data according to an embodiment of the present invention. With the content data 671 of layer code 1 as an example, the layer code content data format contains a layer code reference number 71 and a property code starting address 72, a property code length 73, property code content data 74, an identity code starting address 75, an identity code length 76, and identity code content data 77 of the layer code. In addition, the content data of each layer code have the same format. Thus, when the receiver receives the vector map data, the receiver obtains a map in a vector image format according to the foregoing content by using a map engine application program. Accordingly, the purpose of reducing the time of transmitting a map can be accomplished.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A map transmission system, comprising:
a database, storing at least one map data;
a sender, generating a map frame data based on the map to be transmitted, converting the map frame data into a vector map data through the database, and transmitting the vector map data to a remote site via a network; and
a receiver, receiving the vector map data, displaying the vector map data by using a map engine application program.

2. The map transmission system as claimed in claim 1, wherein the sender comprises a personal digital assistant (PDA), a navigation device, or a mobile phone with global positioning system (GPS).

3. The map transmission system as claimed in claim 1, wherein the receiver comprises a PDA, a navigation device, or a mobile phone with GPS.

4. The map transmission system as claimed in claim 1, wherein the map frame data comprises coordinates of a top left corner and a bottom right corner of the map.

5. The map transmission system as claimed in claim 1, wherein the map comprises a plurality of layers.

6. The map transmission system as claimed in claim 5, wherein the vector map data comprises layer codes, layer addresses, and layer content data of the layers.

7. The map transmission system as claimed in claim 1, wherein the vector map data is transmitted in a packet.

8. The map transmission system as claimed in claim 7, wherein the packet of the vector map data complies with hypertext transmission protocol (HTTP).

9. The map transmission system as claimed in claim 7, wherein the packet of the vector map data complies with simple mail transfer protocol (SMTP).

10. A map transmission method, comprising:
setting a database for storing at least one map data;
providing a sender for generating a map frame data based on the map to be transmitted, converting the map frame data into a vector map data through the database, and transmitting the vector map data to a remote site via a network; and
providing a receiver for receiving the vector map data and displaying the vector map data by using a map engine application program.

11. The map transmission method as claimed in claim 10, wherein the sender comprises a PDA, a navigation device, or a mobile phone with GPS.

12. The map transmission method as claimed in claim 10, wherein the receiver comprises a PDA, a navigation device, or a mobile phone with GPS.

13. The map transmission method as claimed in claim 10, wherein the map frame data comprises coordinates of a top left corner and a bottom right corner of the map.

14. The map transmission method as claimed in claim 10, wherein the map comprises a plurality of layers.

15. The map transmission method as claimed in claim 14, wherein the vector map data comprises layer codes, layer addresses, and layer content data of the layers.

16. The map transmission method as claimed in claim 10, wherein the vector map data is transmitted in a packet.

17. The map transmission method as claimed in claim 16, wherein the vector map data complies with HTTP.

18. The map transmission method as claimed in claim 16, wherein the vector map data complies with SMTP.
